(19) United States
(12) Patent Application Publication
(10) Pub. No.: US 2022/0032268 A1
(43) Pub. Date: Feb. 3, 2022

(54) AMINE-APPENDED CHEMICAL SORBENT

(71) Applicant: BATTELLE MEMORIAL INSTITUTE, Columbus, OH (US)

(72) Inventors: David Hopkinson, Morgantown, WV (US); Ali K. Sekizkardes, Pittsburgh, PA (US)

(21) Appl. No.: 17/380,091

(22) Filed: Jul. 20, 2021

Related U.S. Application Data
(60) Provisional application No. 63/059,369, filed on Jul. 31, 2020.

(51) Int. Cl. B01J 20/26; C08G 65/40; C08G 65/48; B01J 20/28; B01J 20/30

(52) U.S. Cl. CPC B01J 20/265; C08G 65/40; C08G 65/48; B01J 20/3007; B01J 20/28023; B01J 20/3085; B01J 20/28016

(57) ABSTRACT

A chemical structure, and a process for synthesizing the chemical structure, of:

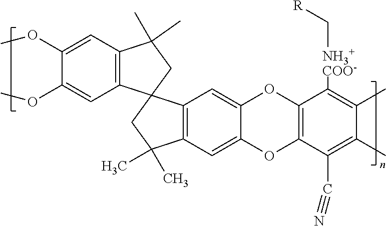

### CROSS REFERENCE TO RELATED APPLICATIONS

This application claims the benefit of U.S. Provisional Patent Application Ser. No. 63/059,369, filed Jul. 31, 2020, entitled “AMINE-APPENDED CHEMICAL SORBENT”, the disclosure of which is hereby incorporated by reference.

### BACKGROUND

### Field of the Disclosure

The present disclosure relates generally to sorbents and, more particularly, to chemical sorbents.

### Description of Related Art

Porous sorbents, such as porous organic polymers (POPs), have been studied as a means for capturing post-combustion carbon dioxide (CO₂). Typically, the interaction between CO₂ and POPs is primarily due to physical adsorption, also known as physisorption, which results in a CO₂ uptake that seldom exceeds twenty (20) cubic centimeters per gram (cc/g). Consequently, sorbents that can capture higher concentrations of CO₂ are important areas of research.

### SUMMARY

The present disclosure relates to chemical sorbents and, also, to processes for synthesizing chemical sorbents.

As such, one embodiment of the invention is a chemical structure of:

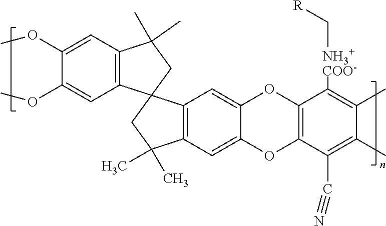

Another embodiment is a process that functionalizes a polymer with intrinsic microscopy (PIM-1) with a carboxylic acid (—COOH) group (with the functionalizing of the PIM-1 resulting in a hydrolyzed polymer (PIM-1-Cn)). Thereafter, the PIM-1-Cn is reacted with a primary amine through an acid-base interaction, thereby resulting in a primary amine-appended sorbent (PIM-1-Cn-TA).

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A is diagram showing one embodiment of a polycondensation reaction of one-dimensional monomers to synthesize a polymer with intrinsic microscopy (PIM-1).

FIG. 1B is a diagram showing one embodiment of a chemical reaction that functionalizes the PIM-1 with a carboxylic acid (—COOH) group.

FIG. 1C is a diagram showing one embodiment of a reaction in which tris(2-aminoehtyl)amine (TAEA) is appended to the PIM-1 as a primary amine.

FIG. 1D is a diagram showing another embodiment of a reaction for appending different primary amines (denoted as R) to the PIM-1.

FIG. 2 is a graph showing Fourier Transform (FT) infrared (IR) spectra for several functionalized PIM-1 sorbents.

FIG. 3A is a graph showing full FT-IR spectra for several PIMs.

FIG. 3B is a graph showing expanded FT-IR spectra from approximately 3800 cm⁻¹ to approximately 2500 cm⁻¹ for several PIMs.

FIG. 3C is a graph showing expanded FT-IR spectra from approximately 1800 cm⁻¹ to approximately 1300 cm⁻¹ for several PIMs.

FIG. 4 is a chart showing Brunauer-Emmett-Teller (BET) surface area properties for several PIMs.

FIG. 5 is a chart showing carbon dioxide (CO₂) adsorption and desorption isotherms of several PIMs.

FIG. 6 is a chart showing results in one embodiment of a CO₂ update cyclability test.

FIG. 7 is a chart showing CO₂ adsorption and desorption isotherms of several PIMs.

FIG. 8 is a graph showing Pore size distribution (PSD) of several PIMs.

FIG. 9 is a graph showing CO₂ adsorption (filled circles) and desorption (open circles) isotherms of several PIMs.

FIG. 10 is a chart showing CO₂ adsorption cyclability test at 0.15 bar and 298K.

FIG. 11 is a graph showing CO₂ isostatic heats of adsorption for several PIMs.

FIG. 12 is a graph showing Dry (green) and humid (blue) CO₂ adsorption breakthrough results on a PIM at 308K.

FIG. 13 is a table summarizing CO₂ uptake and Qₛₜ of sorbents.

FIG. 14 is a photograph of several PIMs.

FIG. 15 is a graph illustrating nitrogen (N₂) adsorption isotherms (77K) of several PIMs.

FIG. 16 is a chart illustrating BET surface area of several PIMs.

FIG. 17 is a graph illustrating nitrogen (N₂) adsorption isotherms (77K) of several more PIMs.

FIG. 18 is a graph showing full range (0 to 22 nanometer (nm)) pore size distribution calculated by a non-local density functional theory (NLDFT) method for several PIMs.

FIG. 19 is a graph showing a zoomed-in (0 to 7.5 nm) pore size distribution for several PIMs.

FIG. 20 is a table showing a degree of nitrile functionalization based on FT-IR spectra of several PIMs.

FIG. 21 is a graph showing a full range (4000 to 750 cm⁻¹) FT-IR spectra of several PIMs.

FIG. 22 is a graph showing expanded (1800 to 1300 cm⁻¹) FT-IR spectra of several PIMs.

FIG. 23 is a graph showing thermogravimetric analysis of PIM-1.

FIG. 24 is a graph showing thermogravimetric analysis of two more PIMs.

FIG. 25 is a graph showing thermogravimetric analysis of two more PIMs.

FIG. 26 is a graph showing thermogravimetric analysis of two more PIMs.

FIG. 27 is a graph showing CO₂ adsorption/desorption isotherms (at 298K and 313K) of PIM-1.

FIG. 28 is a graph showing CO₂ adsorption/desorption isotherms (at 298K and 313K) of PIM-1-C1-TA.

FIG. 29 is a graph showing CO₂ adsorption/desorption isotherms (at 298K and 313K) of PIM-1-C2-TA.

FIG. 30 is a graph showing CO₂ adsorption/desorption isotherms (at 273K, 298K, and 313K) of PIM-1-C3-TA.

FIG. 31 is a graph showing CO₂ and N₂ adsorption isotherms at 298K of PIM-1.

FIG. 32 is a graph showing initial slopes of the isotherms of FIG. 31.

FIG. 33 is a graph showing CO₂ and N₂ adsorption isotherms at 298K of PIM-1-C3.

FIG. 34 is a graph showing initial slopes of the isotherms of FIG. 33.

FIG. 35 is a graph showing CO₂ and N₂ adsorption isotherms at 298K for PIM-1-C3-TA.

FIG. 36 is a graph showing initial slopes of the isotherms of FIG. 35.

FIG. 37 is a graph showing adsorption and regeneration breakthrough curves of CO₂ and H₂O at 308K for PIM-1-C3-TA.

FIG. 38 is a table showing CO₂ adsorption performance of high-performance PIM-based sorbents.

### DETAILED DESCRIPTION OF THE EMBODIMENTS

Porous sorbents are one class of material being studied for use in carbon dioxide (CO₂) capture applications. In the last decade, a new class of porous materials, porous organic polymers (POPs) have emerged, including porous aromatic frameworks (PAFs), porous polymeric networks (PPNs), benzimidazole linked polymers (BILPs) and hyper crosslinked polymers (HPCs). In general, POPs have been reported as high surface area materials with a highly stable polymer structure resulting from the covalent bonding between the monomers. However, the CO₂ uptake capacity of most POPs is not able to exceed twenty (20) cubic centimeters per gram (cc/g) (at 0.15 bar CO₂ and 298 Kelvin (K)), as the interaction between CO₂ and POPs is primarily due to physisorption. Although there have been several efforts to append primary amines to POPs through either amine-impregnation or grafting methods, drawbacks such as harsh synthesis, poor scalability, and poor processability have been a hurdle for POPs as a breakthrough for CO₂ capture.

Polymers with intrinsic microporosity (PIMs) are POPs that can be synthesized inexpensively and under mild reaction conditions. In contrast to most POPs, PIMs can be processed into thin films and fibers. Consequently, studies on PIMs have focused on gas separation membrane applications in which they feature exceptionally high permeability and moderate selectivity for several different light gas pairs. Although PIM-based membranes have been among the best performing gas separation materials, little is known about PIMs as solid sorbents for CO₂ capture or other gas separations. While PIMs possess the high surface area and permanent microporosity desired for a sorbent, they also suffer from low CO₂ adsorption capacity (less than 10 cc/g at 0.15 bar and 298K) due to relatively large (greater than 1 nm) non-polar micropores as well as some mesopores.

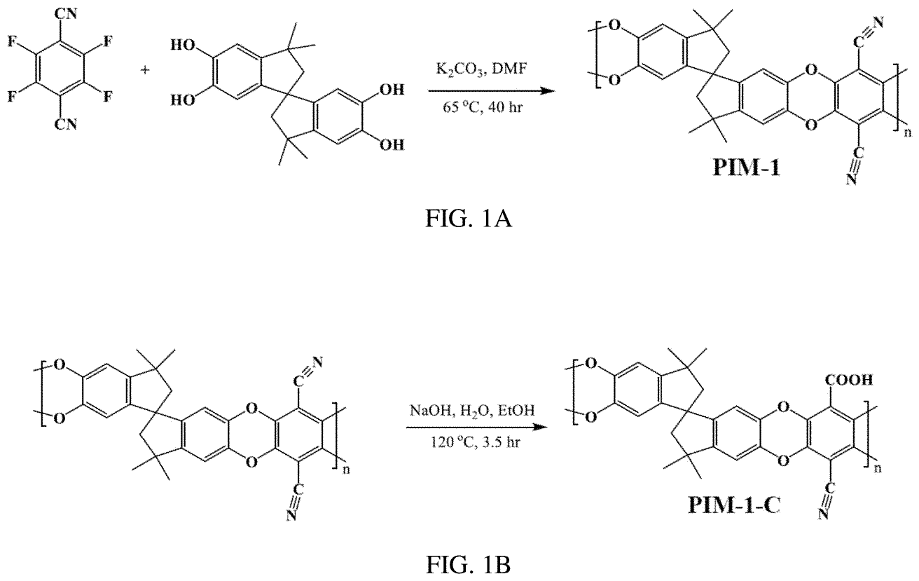

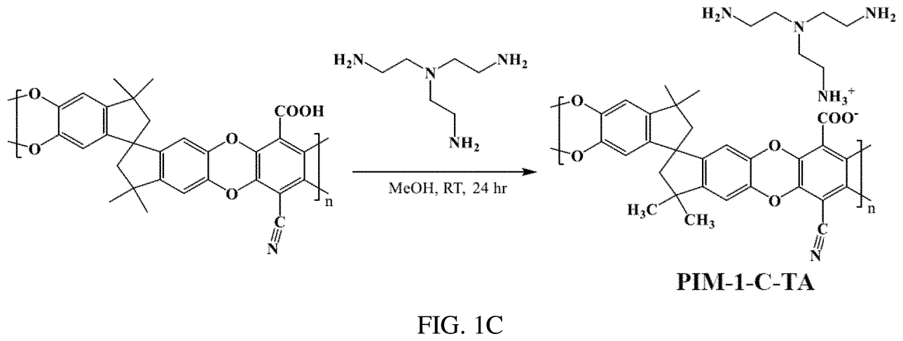

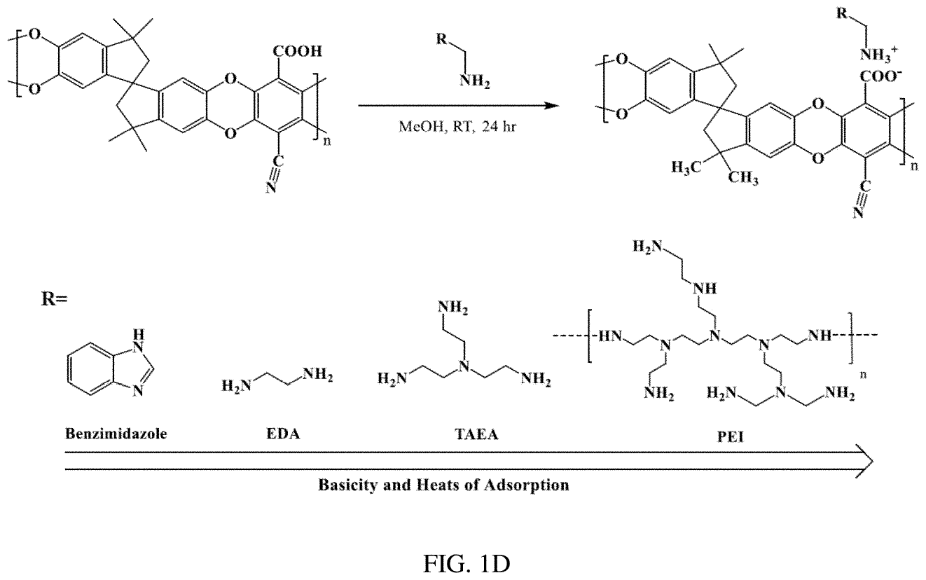

To address these shortcomings, this disclosure teaches a chemical structure with excellent chemical stability, improved CO₂ separation performance, and less amine leeching when compared to comparable conventional structures. Also, a process for synthesizing the chemical structure is disclosed. Specifically, the desired chemical structure begins with the synthesis of one of the most studied PIM (namely, PIM-1). This disclosure further teaches post-synthesis functionalizing PIM-1 with carboxylic acid (—COOH) and amide (CONH₂) functional groups to create a sorbent medium with a moderate surface area and strong bonding sites for primary amines (FIGS. 1C and 14). Also disclosed is gas separation performance for this sorbent using both dry and humidified feed gas under conditions that are relevant to post-combustion CO₂ capture.

Having provided a broad technical solution to a technical problem, reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

As an initial matter, all chemicals were purchased from Sigma Aldrich and were used without any further purification. Gas adsorption and surface area measurements, as described herein, were collected using ultra-high purity (UHP) gases via a gas sorption analyzer from Quantachrome Corporation. Adsorption and desorption isotherms were collected at 298K and 313K. Regeneration of sample was performed at 258K under vacuum. Fourier transform (FT) infrared (IR) spectra were collected using a Bruker Vertex. CO₂ adsorption-desorption cycling was conducted in a lab-scale, custom built packed bed reactor. Approximately 0.16 g of sorbent was loaded into a stainless-steel tube (⅜ inch outer diameter (OD)) and held in place using quartz wool plugs. The sorbent was first pretreated at 358K under helium (He) flow (approximately one hundred (100) cubic centimeters per minute (cc/min)). Then, CO₂ sorption was carried out at 308K using a gas mixture of 10 vol. % CO₂/He at 100 standard cubic centimeters per minute (sccm). Performance under wet conditions was also determined using a gas mixture 10% CO₂-3% H₂O/He at 100 sccm at 308K. For both cases, desorption was carried out in two steps: first, isothermal pressure swing desorption at 308K and second a temperature swing desorption during which the sample was heated to 358K. The sample was then tested under dry cycle conditions to determine its performance after exposure to steam. The gas effluent was monitored with a Thermostar® mass spectrometer.

With these materials and underlying processes in mind, this disclosure teaches a new and novel sorbent preparation with post-synthetic functionalization followed by amine impregnation, as well as characterization of the sorbent and CO₂ uptake testing. Specifically, the invention is the first example of a sorbent material based on carboxylic acid (—COOH) functionalized polymers with intrinsic microporosity (PIM-1-C) that are impregnated with primary amines. Acid functionalization of PIM-1 leads to acid-base interaction with the amines which provides excellent chemical stability, the avoidance of amine leaching, and improved CO₂ separation performance compared with other amine impregnated polymer sorbents. In addition to the carboxylic acid functional groups, there are a considerable amount of amide functional groups present in the polymer due to hydrolysis of the nitrile groups of PIM-1. Therefore, in addition to acid functional groups, the disclosed polymers provide hydrogen bonding sites for additional stability with primary amine molecules.

In other words, this disclosure teaches a sorbent design that comprises post synthetically modified PIM-1 using primary amines. Moreover, this disclosure teaches amine-appendence in PIMs through acid-base interaction to afford more stable aminated sorbent, as compared to most of the aminated sorbents prepared by amine impregnation.

With this in mind, PIM-1 is an organic microporous polymer and similar to conventional polymers, PIM-1 is synthesized by polycondensation reaction of one-dimensional monomers. As shown in FIG. 1A, PIM-1 was synthesized via 3,3,3′,3′-tetramethyl-1-1′-spirobisindane-5,5′,6,6′-tetrol and 2,3,5,6-tetra-fluorophthalonitrile. Monomers were dissolved in anhydrous dimethylformamide (DMF) and K₂CO₃ was added in the solution and the reaction was stirred at 65° C. for three days. Water was added after cooling the reaction mixture and the product was separated by filtration. Further purification was performed by reprecipitation from CHCl₃ solution with MeOH and a bright yellow solid product was produced after thermal activation at 120° C. It should be noted that PIM-1 possesses high chemical and thermal stability, processability, and scalability properties. In contrast to most polymers, PIM-1 features unprecedented surface area and free volume because its monomers 3,3,3′,3′-tetramethyl-1,1′-spirobisindane-5,5′,6,6′-tetrol (TTSBI) and 1,4-dicyanotetrafluorobenzene (DCTB) provide a combination of high rigidity and contorted chain packing properties to PIM-1. To date, PIM-1 was primarily considered for gas separation application in the form of gas separation membranes as the polymer can be processed in membrane films. However, there are little, if any, disclosures on PIMs as a sorbent material in gas capture applications.

Next, as shown in FIG. 1B, for carboxylic-acid-functionalized PIM-1 (designated as PIM-1-Cn (with n being an integer that represents an index for labeling purposes)) sodium hydroxide (NaOH) (20 g) was added to solution of water (40 ml)/ethanol (50 ml). The synthesized PIM-1 (500 milligram (mg)) was placed in the solution. Reaction time and temperatures were 24 hours at 25° C., 1 hour at 120° C., and 3.5 hours (or 210 minutes) at 120° C. for PIM-1-C1, PIM-1-C2 and PIM-1-C3, respectively. Products were filtered and placed in pH 4 water for stirring overnight at ambient conditions and at 105° C. for 1 hour. After washing with water and methanol, polymers were thermally activated for the amine loading step. In other words, the synthesized PIM-1 was post-synthetically functionalized with carboxylic acid (—COOH) groups. The functionalization reaction was performed by conversion of nitrile (—CN) groups of PIM-1 into the —COOH. The conversion level was tuned from 10%-COOH to 80%-COOH (as shown in FIG. 1B) by altering reaction time.

To prepare an amine-appended sorbent (as shown in FIG. 1C), PIM-1-C(100 mg) was added in 20 ml methanol solution of tris(2-aminoethyl)amine (TAEA) and stirred for 24 hours at ambient conditions. The sorbent was filtered and washed with hexane. The product was thermally activated at 85° C. under vacuum prior to characterization studies. The functionalized PIM-1 polymers (PIM-1-Cs) reacted with TAEA through acid-base interaction. Sorbent products were denoted as PIM-1-C1-TA, PIM-1-C2-TA, and PIM-1-C3-TA with respect to 30%, 50% and 80% —COOH group functionalization in the sorbent. A model reaction scheme is also depicted in FIG. 1D to show alterative versions of the sorbent.

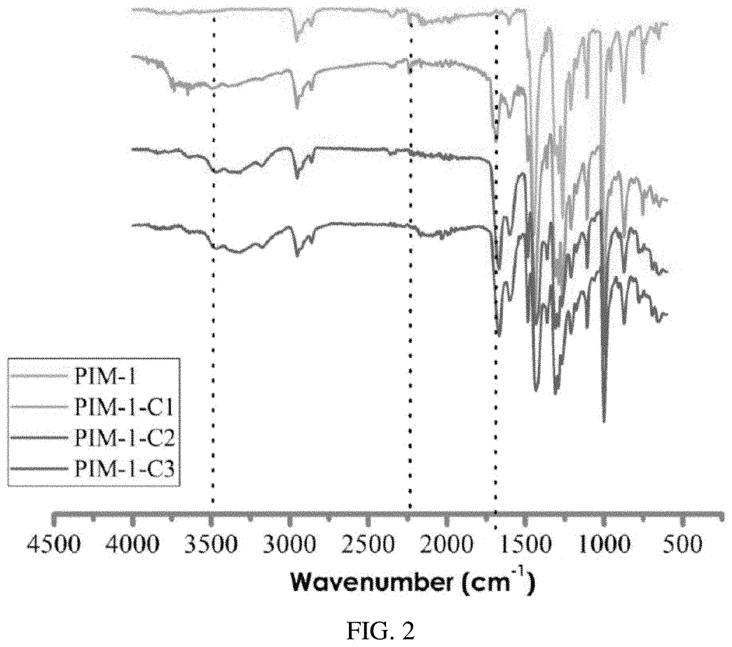

Sorbents were characterized by Fourier transform infrared spectroscopy (FT-IR) to probe functional groups of the neat polymer (PIM-1), functionalized polymers (PIM-1-C) and the amine-loaded polymer (PIM-1-C-TA). While neat PIM-1 showed characteristic FT-IR stretching bands, increasing carboxylic acid content in PIM-1 resulted in broad peaks between 3000-3500 cm⁻¹ and strong peaks at 1660 cm⁻¹, due to —COOH and —C═O bonds, respectively. The nitrile conversion into carboxylic acid was also evident with decreasing peak intensity at around 2300 cm⁻¹ for polymers PIM-1-C1, PIM-1-C2, and PIM-1-C3, as shown in FIG. 2.

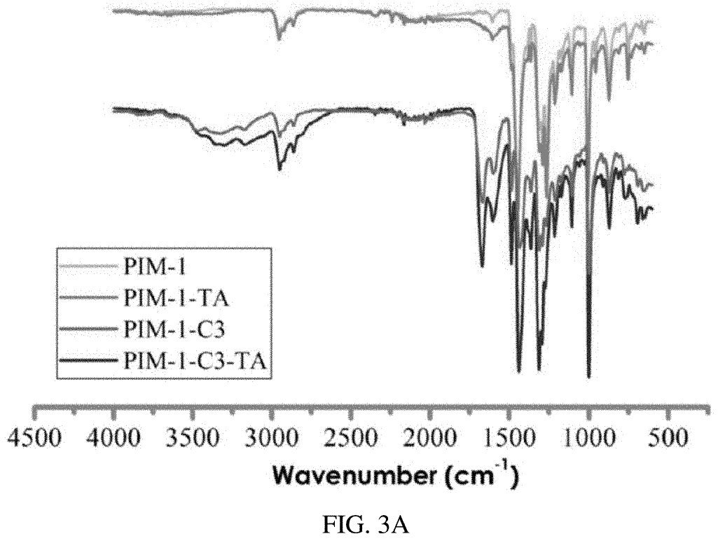

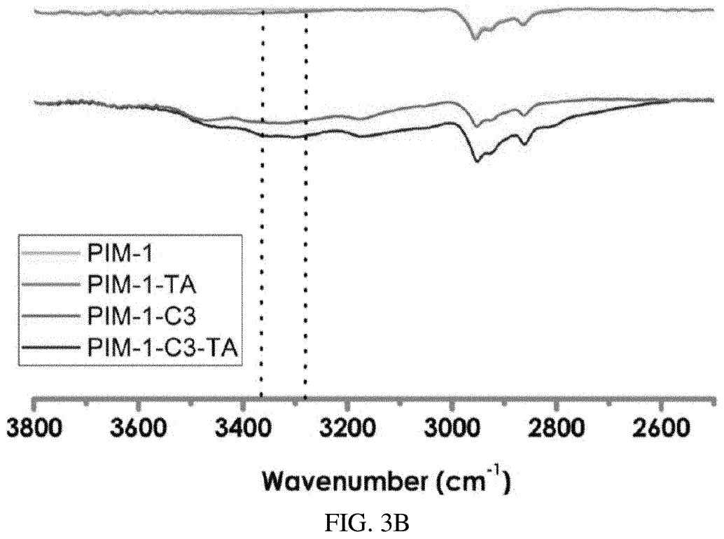

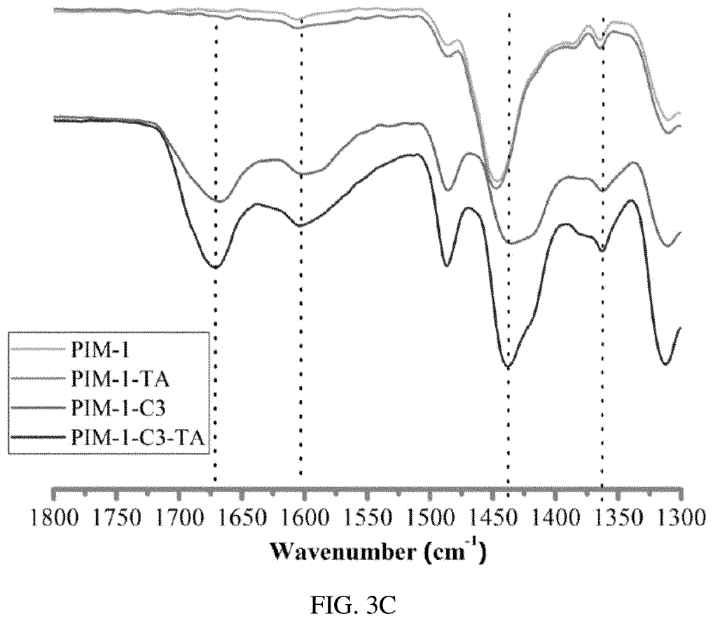

FT-IR analysis was performed on the amine loaded polymers. FT-IR spectra of the most carboxylated PIM-1 sample, PIM-C3, and its aminated sorbent, PIM-1-C3-TA, were depicted in FIG. 3A. In addition, neat PIM-1 was also loaded with TAEA under the same reaction conditions (FIG. 1C) to analyze the carboxylic acid-primary amine interaction within PIM-1-C3-TA in comparison with nitrile-amine interaction in PIM-1.

The PIM-1 sample, which was loaded with the primary amine (TAEA), PIM-1-TA, showed nearly the same FT-IR spectrum as the neat PIM-1. There is very weak and broad peak observed between 3300 cm⁻¹ and 3600 cm⁻¹, thereby suggesting minimal amine-retention in the PIM-1 polymer. This indicates that the most of TAEA is leached out from PIM-1 during the purification step due to low interaction ability between PIM-1 and TAEA.

On the other hand, amine loading in carboxylated PIM-1 sample, PIM-1-C3-TA, showed a distinct FT-IR spectrum when compared to neat PIM-1-C3. Characteristic N—H stretching bands for primary amine (—NH₂) at 3250 to 3450 cm⁻¹ was observed for PIM-1-C3-TA, as shown in FIG. 3B. In addition, FT-IR stretching bands of PIM-1-C3 at 1672 cm⁻¹, 1606 cm⁻¹, and 1432 cm⁻¹ showed a shift to higher wave numbers with the amine loading (PIM-1-C3-TA, FIG. 3C). Thus FT-IR spectrum of the sorbent PIM-1-C3-TA not only proved that TAEA is present in the sorbent, it also showed that primary amine is interacting with the sorbent.

Sorbents were also characterized by volumetric gas sorption analysis (Quantachrome, NOVA) to analyze surface area, pore volume and pore size distribution properties. Nitrogen adsorption isotherms (77K) were used to calculate Brunauer-Emmett-Teller (BET) surface area of carboxylated PIM-1 polymers (PIM-1-Cs). The surface area of PIM-1 was calculated as 840 m²/g and the surface area of the functionalized PIM-1 polymer showed lower surface area compared to PIM-1 as 696, 498 and 495 m²/g for PIM-1-C1, PIM-1-C2 and PIM-1-C3, respectively. While decreasing surface area property in the polymer indicates that the chemical structure of PIM-1 was altered after post-synthetic modification, retaining high surface area (nearly 500 m²/g) after over 80%-COOH (PIM-1-C3) functionalization is significant for the subsequent amine loading step.

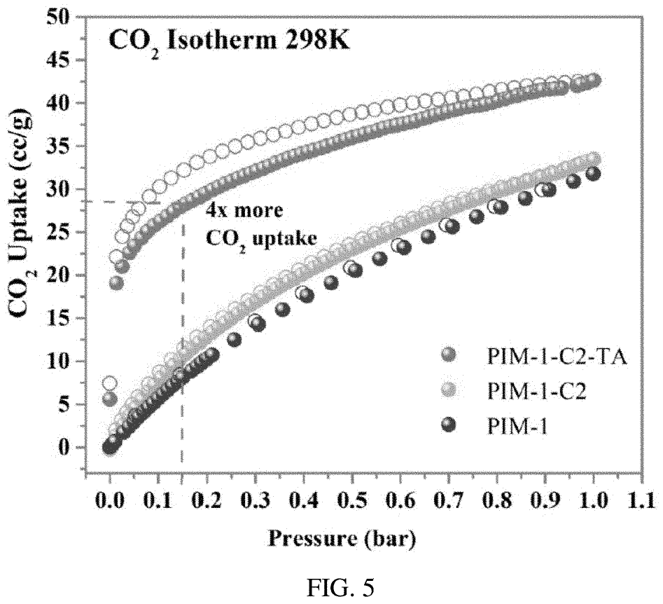

CO₂ uptake performance of the sorbents were evaluated by CO₂ adsorption isotherms collected via volumetric gas adsorption analyzer (Quantachrome and Micromeritics 3Flex). Neat PIM-1 showed low CO₂ adsorption capacity (7 cc/g, 298K) at 0.15 bar CO₂ pressure, which is the target partial pressure for post combustion flue gas separation. The functionalized PIM-1 polymer (PIM-1-C2) performed slightly better in CO₂ adsorption (10 cc/g) compared to PIM-1, given the —COOH groups present in PIM-1-C2, which can interact with CO₂. TAEA-loaded PIM-C2 polymer, PIM-1-C2-TA, showed very high CO₂ uptake compared to PIM-1 by adsorbing 28 cc/g CO₂ at the given conditions. As shown in FIG. 5, a noticeable hysteresis between adsorption and desorption isotherms of PIM-1-C2-TA proves that the sorbent is not only consisted of physisorption sites, but also consisted of chemisorption sites. This isotherm behavior suggests that the sorbent retains a considerable amount of primary amines in its structure.

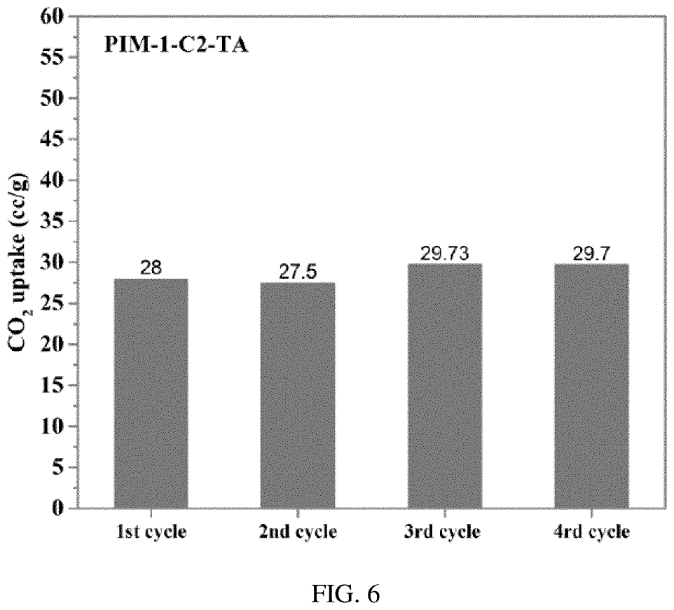

Several cyclability measurements on the sorbent, PIM-1-C2-TA, was performed. It is evident, as shown in FIG. 6, that the CO₂ uptake capacity of the sorbent is regenerable after each desorption step which was at 80° C. and under vacuum.

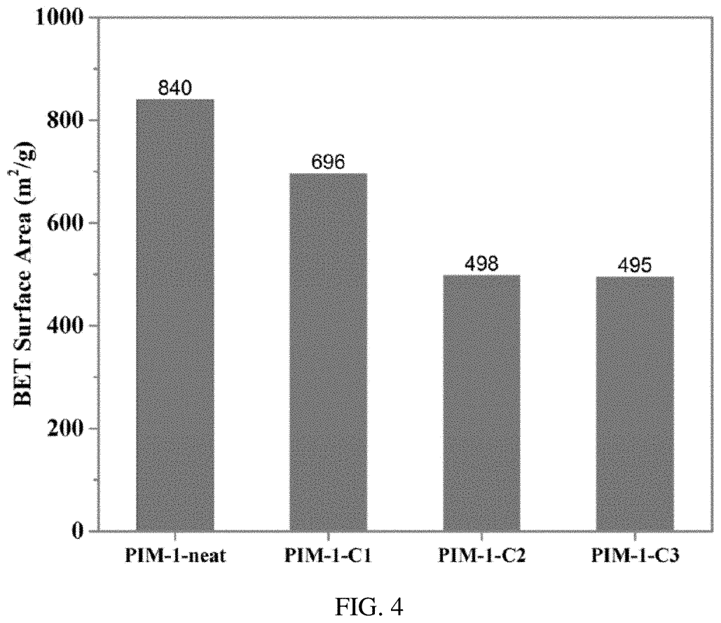

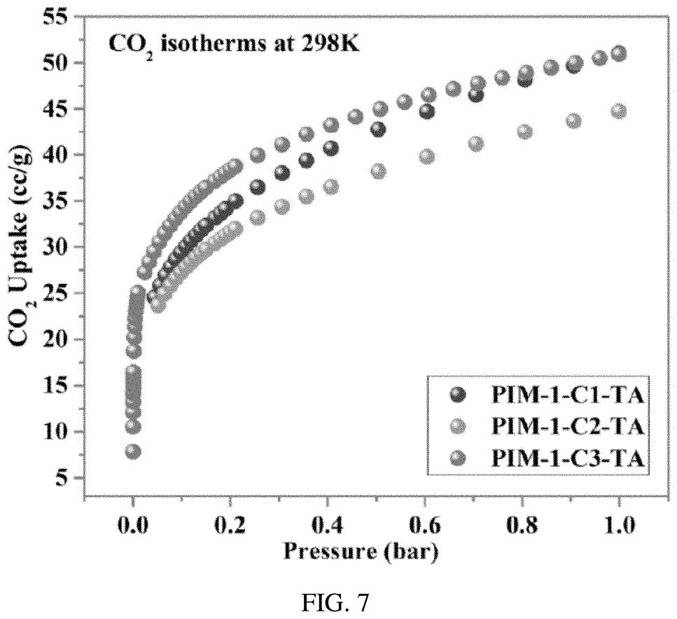

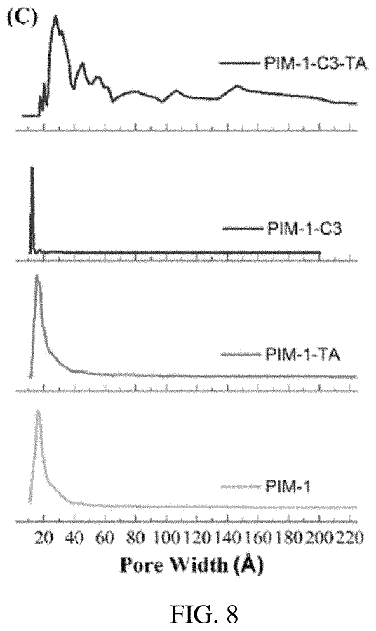

CO₂ uptake capacities of other two aminated sorbents which are based on 30%-COOH and 80%-COOH functionalized PIM-1 sample: PIM-C1-TA and PIM-1-C3-TA, respectively. Both were tested. PIM-1-C1-TA showed higher CO₂ uptake compared to PIM-1-C2-TA at higher pressures, despite having less —COOH groups in the polymer. This result can be attributed to higher surface area property of the former (which is shown in FIG. 4). On the other hand, PIM-1-C2-TA showed more steep CO₂ uptake behavior at low pressure suggesting more amine-loading in the sorbent compared to PIM-1-C1-TA. The third sorbent, PIM-1-C3-TA, which has the highest —COOH functional groups, showed the highest CO₂ uptake performance (37 cc/g) at 0.15 bar (as shown in FIG. 7). This remarkable CO₂ uptake capacity is more than five (5) times higher than neat PIM-1 and appears to be one of the highest achieved in all polymer-based materials.

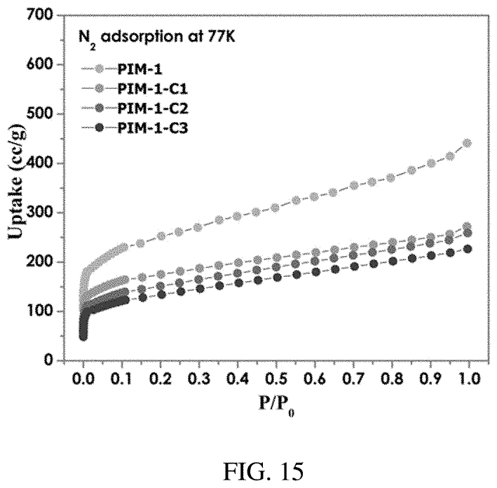

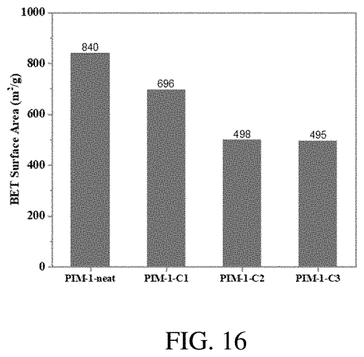

In other embodiments, the PIM-1 was modified using a reaction temperature of 58° C. and a shorter duration of reaction (40 hours) to afford higher surface area. The synthesized PIM-1 showed a high surface area of 840 m²/g with a pore size distribution around 1 nm (as shown in FIGS. 15-16). Subsequently, the PIM-1 was post-synthetically functionalized with carboxylic acid groups to afford the hydrolyzed polymer, PIM-1-C. The degree of the polymer functionalization was controlled by adjusting the time and temperature of the reaction. Similar to the process, as described above, the hydrolyzed polymers were denoted as PIM-1-C1, PIM-1-C2, and PIM-1-C3 for the reaction times of 24 hours at 25° C., 1.5 hours (or 90 minutes) at 120° C., and 3.5 hours (or 210 minutes) at 120° C., respectively. A distinct product color change was observed from fluorescent yellow to off-white as the degree of functionalization increased (as shown in FIGS. 1C and 14).

For these embodiments, FT-IR was performed on the polymers to characterize the hydrolysis reaction of nitrile (—CN) functional groups of PIM-1 (as shown in FIG. 2). The corresponding FT-IR stretching band intensity for —CN at 2250 cm⁻¹ was found to decrease with higher degrees of polymer hydrolysis, while the broad peak intensities between 3000 cm⁻¹ to 3500 cm⁻¹ and, also, at 1660 cm⁻¹ (representing —COOH and —C═O bonds, respectively) were found to be more prominent. Additional absorption bands at 1612 cm⁻¹ showed that a significant amount of amide functional groups were also present in the polymer. The functionalization degree of hydrolyzed PIMs was calculated as 6%, 48%, and 92% for PIM-1-C1, PIM-1-C2, and PIM-1-C3, respectively, from FT-IR absorption bands of —CN at 2240 cm⁻¹, relative to —CH bands in the 2800-3010 cm⁻¹ region.

Functionalized PIM-1 and PIM-1-C polymers were treated with the primary amine, TAEA. In the literature, primary amines were impregnated in sorbents through a solvent evaporation method wherein the loaded amines were trapped in a sorbent media. However, unlike those methods, here, the desired amount of primary amine is dissolved in solvents and porous substrates are mixed with these solutions. Subsequently, solvent evaporation affords an amine-impregnated sorbent. This disclosure follows a less common sorbent preparation method in which an amine solution (in methanol) is stirred with the polymer, excess amine solution is decanted, and the sorbents are thoroughly washed with solvent. Traditional methods provide higher amine-loading as nearly all of the impregnated amine becomes trapped within the sorbent. Conversely, the methods applied in the disclosed embodiments retain less primary amine but provide a more stable sorbent system with stronger interaction.

Polymers were treated with the same amount of TAEA by maintaining the same preparation conditions (solvent concentration, temperature, etc.). Final sorbents were (as noted above) designated as PIM-1-TA, PIM-1-C1-TA, PIM-1-C2-TA, and PIM-1-C3-TA in the order of increasing hydrolysis of nitrile groups in PIM-1 (as shown in FIGS. 1C and 14).

FT-IR analysis was also performed on the amine-loaded polymers. Amine loaded polymers showed a similar trend in their FT-IR absorption bands with respect to their post-synthetic functionalization degree (as shown in FIG. SI-5). FT-IR spectra of the most highly hydrolyzed PIM-1 sample, PIM-1-C3, and its TAEA appended sorbent, PIM-1-C3-TA, are depicted in FIG. 1B. As a control sample, neat PIM-1 was also loaded with TAEA under the same conditions so that the degree of interaction with the amine could be compared between the hydrolyzed PIM-1 (PIM-1-C) and neat PIM-1. The unfunctionalized PIM-1 sample loaded with TAEA (PIM-1-TA) showed nearly the same FT-IR absorption spectrum as the neat PIM-1. Weak and broad peak intensities observed in the range of 3200-3500 cm⁻¹, thereby suggesting minimal amine-retention in the PIM-1 polymer, thereby further implying that most of the TAEA leached out from PIM-1 during the solvent washing purification step. This can be attributed to the non-polar (hydrophobic) polymer structure of PIM-1 which does not interact with polar/basic guest molecules such as TAEA.

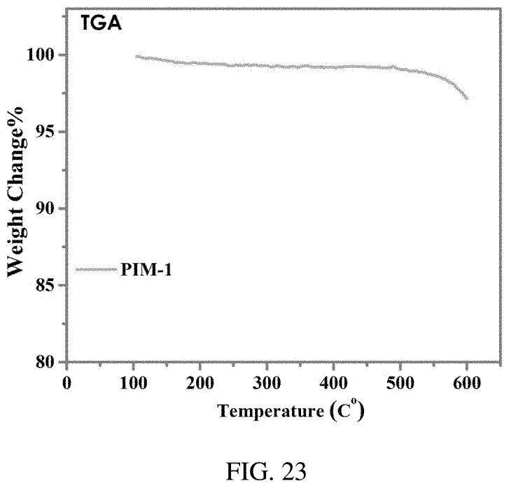

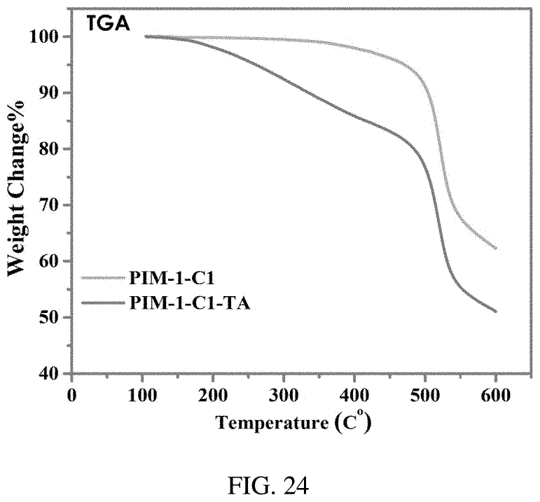

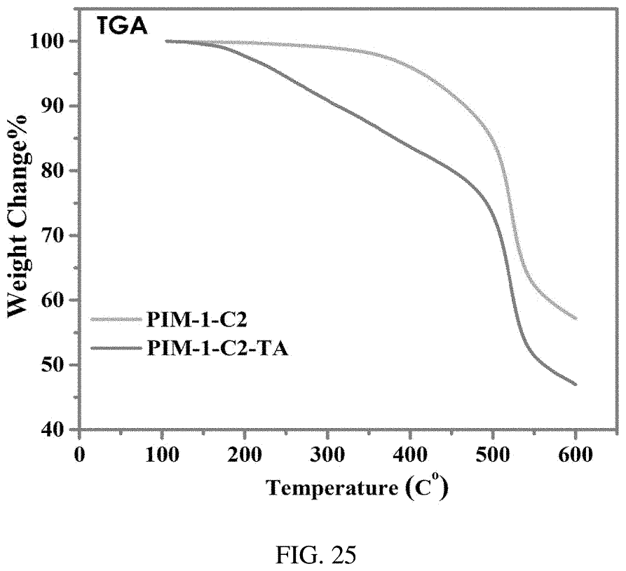

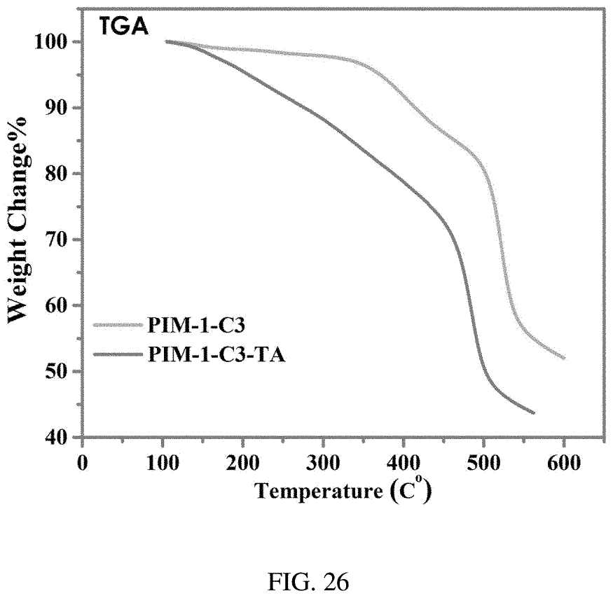

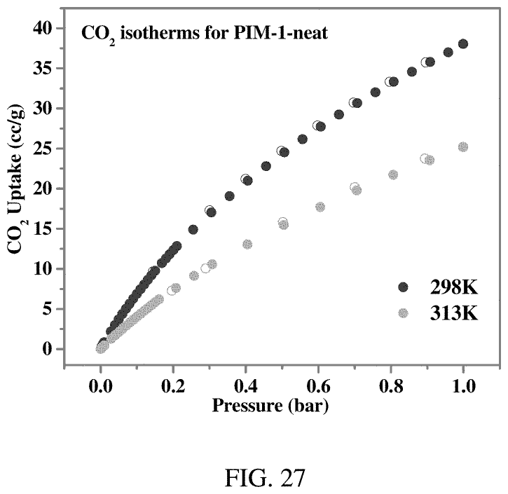

On the other hand, amine appendence in the hydrolyzed PIM-1 sample, PIM-1-C3-TA, showed a distinct FT-IR spectrum compared to PIM-1-C3. Characteristic N—H stretching bands for primary amines (—NH₂) at 3200-3500 cm⁻¹ were observed for PIM-1-C3-TA. Also, FT-IR absorption bands of PIM-1-C3-TA showed a noticeable shift to higher wavenumbers at 1606 cm⁻¹ and 1672 cm⁻¹ when compared with PIM-1-C3 (as shown in FIGS. 3A-C). The FT-IR spectrum of the sorbent PIM-1-C3-TA not only showed that TAEA was successfully appended in the sorbent, but it also suggests that primary amines will only interact strongly with PIM based sorbents that have been functionalized with a compatible appendage such as carboxylic acid. Thermogravimetric analysis (TGA) was performed on sorbents to quantify the amine loading in polymers. TGA showed that the amine amount in PIM-1-C1-TA, PIM-1-C2-TA and PIM-1-C3-TA was 10.6, 12.2, and 13.8 wt %, respectively (as shown in FIGS. 23-26).

Surface area analysis can also be used to confirm polymer functionalization and appending of amines. A polymer with higher surface area can accommodate a greater number of functional groups, which will increase the performance of the sorbent material. Previous reports indicated that hydrolysis of PIM-1 into carboxylic acid and amide functionalized PIM-1 resulted in a reduction of surface area after functionalization. Brunauer-Emmett-Teller (BET) surface areas of the polymers were calculated from nitrogen isotherms collected at 77K. An increasing degree of PIM-1 hydrolysis into PIM-1-C decreased the surface area, which was evidence that the functionalization was successful. Notably, PIM-1-C polymers had high surface area (495-696 m²/g) in every case (as shown in FIGS. 15-16).

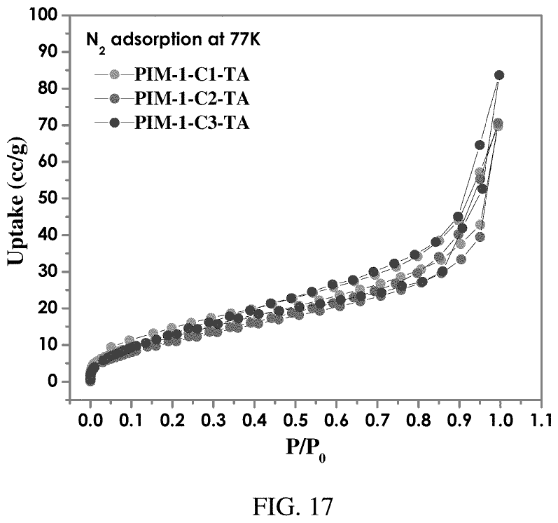

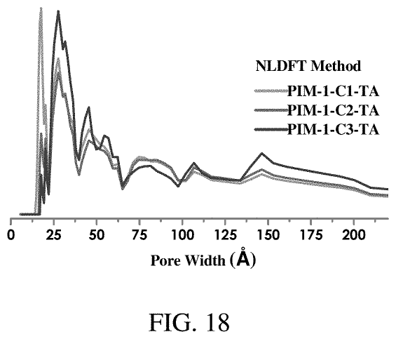

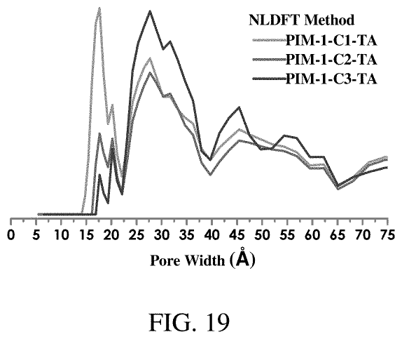

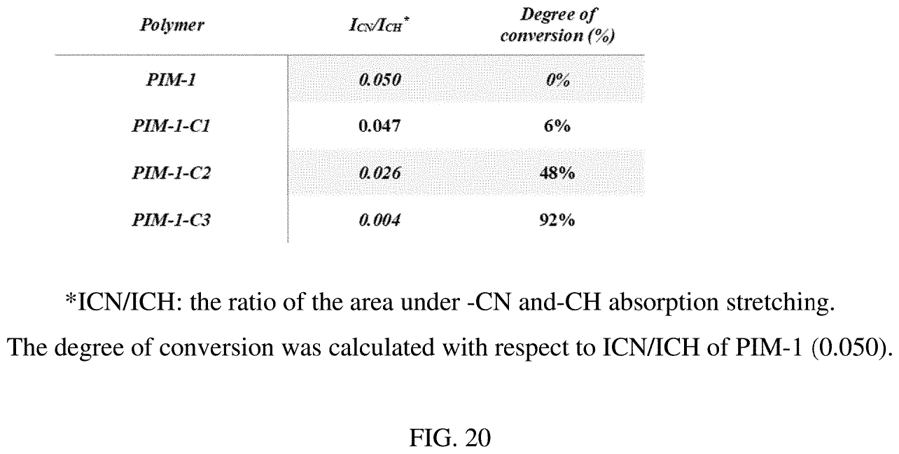

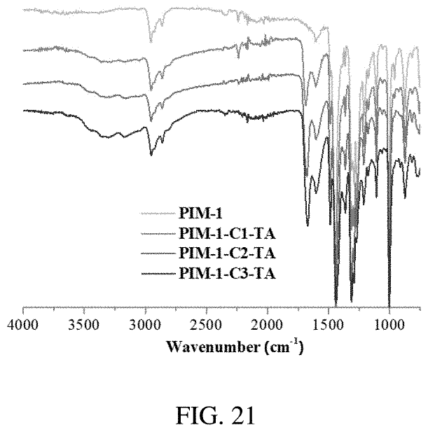

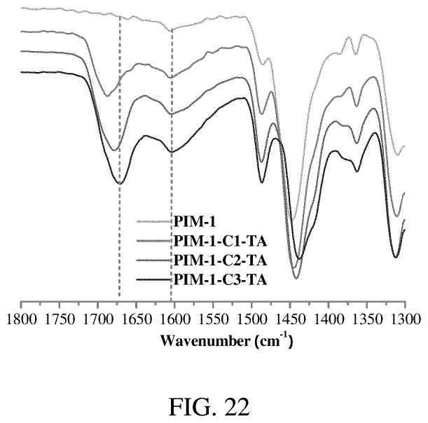

N₂ adsorption (at 77K) of sorbents was found to be lower compared to the functionalized PIMs, indicating the amine intercalation in pores of sorbents (which is shown in FIGS. 17-18). N₂ adsorption isotherms were used to calculate pore size distributions (PSDs) using non-local density functional theory (NLDFT). Hydrolyzed PIM-1-C showed a slight decrease in pore size relative to PIM-1 (Represented in FIG. 1c), thereby indicating that some pore space was occupied by functional groups. Appending amines to the hydrolyzed PIMs caused a shift in the PSD to larger pore sizes, indicating that primary amines were mostly immobilized in the smaller micro-pore region (compare PIM-1-C3-TA to PIM-1-C3 in FIG. 1C). More importantly, the shift in the PSD was more pronounced with greater degrees of carboxylic acid functionalization (as shown in FIGS. 17-18). This supports the hypothesis that primary amines are retained in the sorbents based on the concentration of carboxylic acid functional groups. In the most extreme case, the calculated PSD of PIM-1-TA without the presence of any carboxylic acid functional groups is shown in FIG. 1C. The high concentration of micropores in PIM-1-TA indicates that the pores remain unblocked by amine guest molecules. This comparison suggests that primary amines were only immobilized in the sorbents possessing amine-interaction sites (e.g. COOH, amide, etc.) found in functionalized PIM-1.

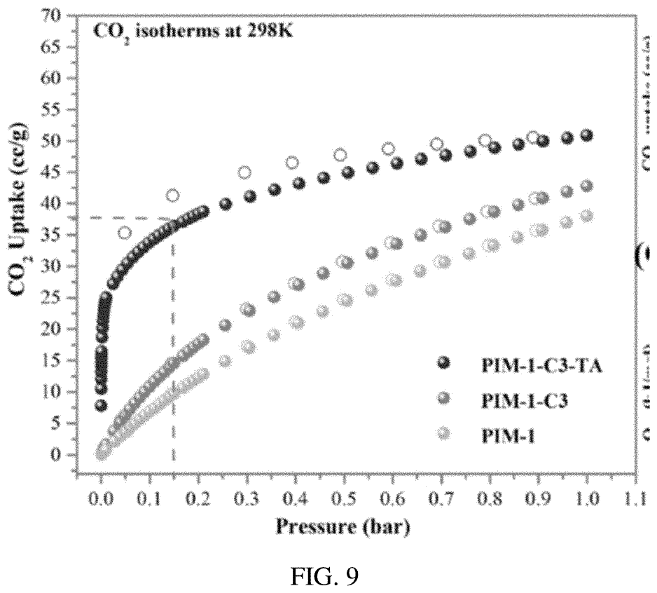

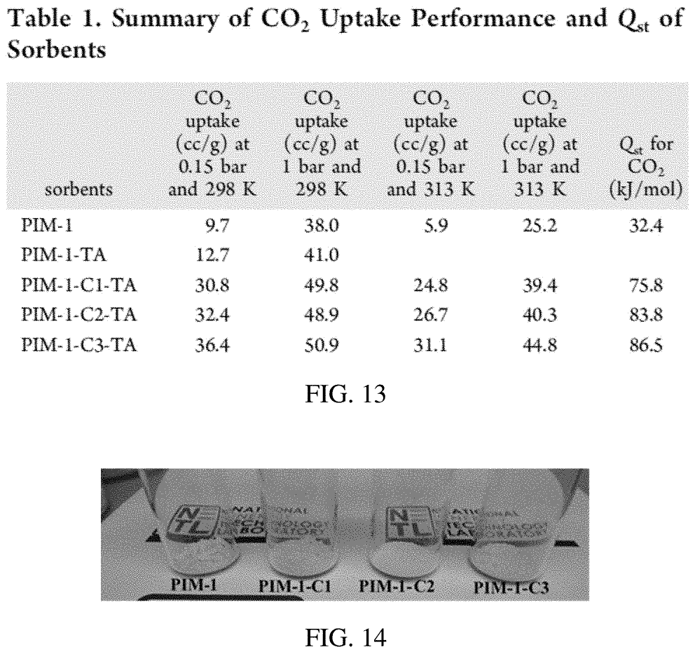

The CO₂ uptake of the sorbents was evaluated from CO₂ adsorption isotherms collected using a volumetric gas adsorption analyzer (which is shown in FIG. 13). Neat PIM-1 showed low CO₂ adsorption capacity (9.7 cc/g, 298 K) at 0.15 bar, which is a typical partial pressure of CO₂ in coal derived post-combustion flue gas (shown in FIG. 9). Hydrolyzed PIM-1 (PIM-1-C3) performed slightly better compared to neat PIM-1, due to the fact that carboxylic acid and amide functional groups can interact with CO₂ molecules.

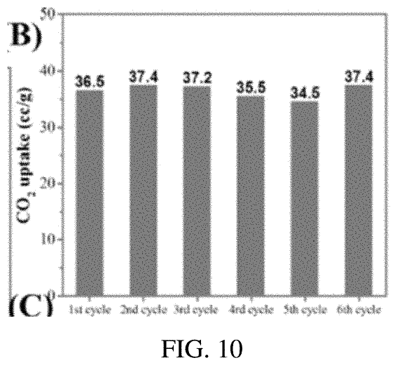

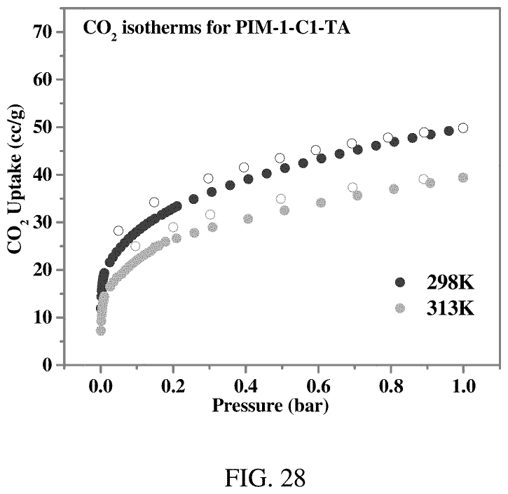

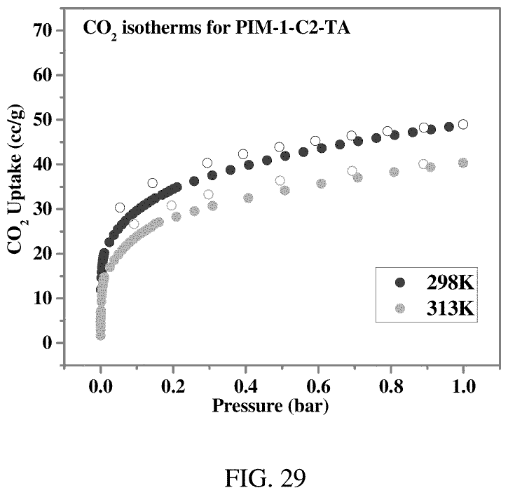

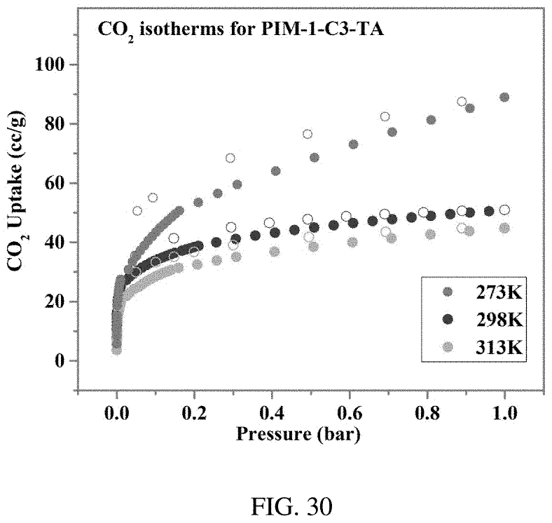

Loading primary amines into the hydrolyzed PIMs resulted in a drastic increase in CO₂ uptake. PIM-1-C1-TA showed higher CO₂ capacity compared to PIM-1-C2-TA at high CO₂ pressure, despite having less hydrolysis functionalization (all of which is shown in FIGS. 13 and 28-29). This result can be attributed to higher surface area of the former (as shown in FIGS. 15-16). On the other hand, PIM-1-C2-TA showed steeper CO₂ uptake at low pressure, suggesting more amine loading in the sorbent compared to PIM-1-C1-TA. PIM-1-C3-TA, which has the highest degree of nitrile hydrolysis showed the highest CO₂ uptake performance of 36.4 cc/g at 0.15 bar and 298K. This value is nearly four-fold higher than the CO₂ uptake of neat PIM-1 and is the highest amount by any PIM-based sorbent that appears to have been reported to date. Six adsorption and regeneration cycles were performed for PIM-1-C3-TA where adsorption was at 0.15 bar and 298K and desorption was at vacuum and 358K. FIG. 10 shows that the sorbent retained its full capacity after each desorption step.

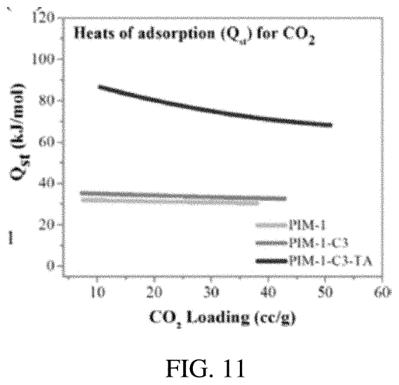

A noticeable hysteresis between adsorption and desorption isotherms also indicates that the primary mode of adsorption for PIM-1-C-TA sorbents is chemisorption (see, FIG. 9). A high isosteric heat of adsorption (Qₛₜ) for CO₂ can serve as an indicator of chemisorption. Qₛₜ values were calculated with the virial equation by fitting CO₂ isotherms collected at 298K and 313K. High Qₛₜ values (75.8-86.5 kilojoules per mol (kJ/mol)) showed that PIM-1-C-TA sorbents retained a considerable amount of primary and secondary amine functional groups (as shown in FIG. 13). On the other hand, the Qₛₜ of neat PIM-1 and hydrolyzed PIM-1-C3 sorbents were calculated as 32 and 35 kJ/mol, respectively (as shown in FIG. 11), similar to reported values in the art.

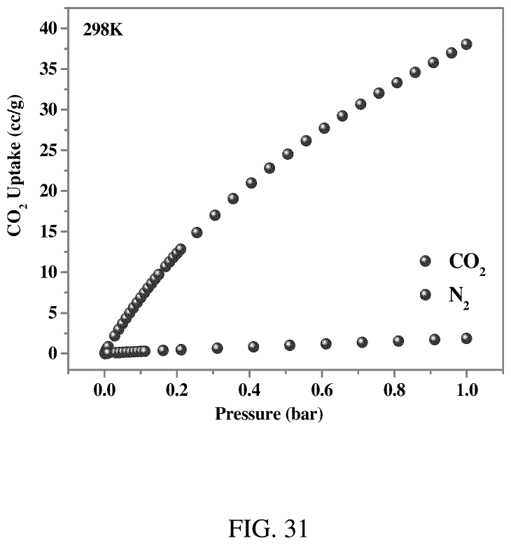

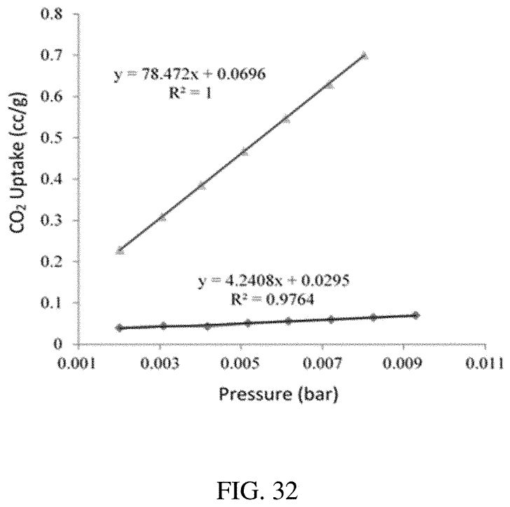

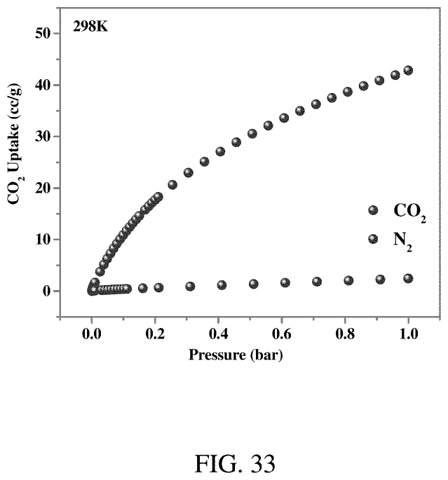

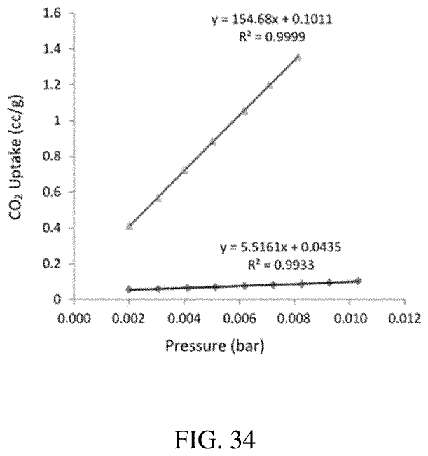

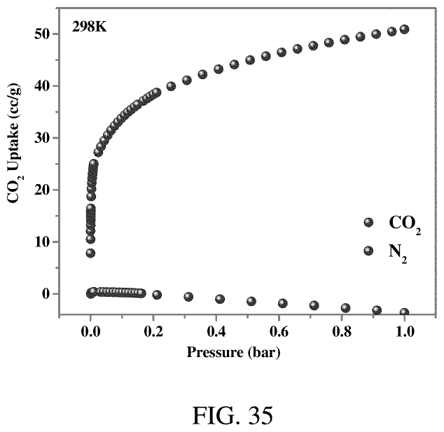

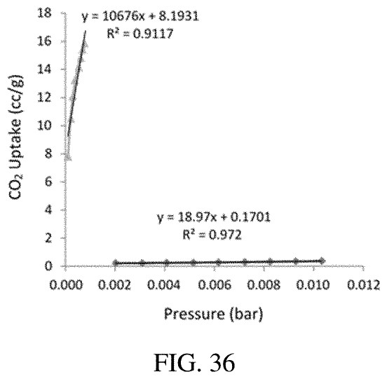

Nitrogen adsorption was also measured to calculate the CO₂/N₂ selectivity. Henry's law initial slope calculations showed that PIM-1-C3-TA has a CO₂/N₂ selectivity of over 500 (as shown in FIGS. 35-36). Compared to the CO₂/N₂ selectivity of PIM-1 (shown in FIGS. 31-32) and hydrolyzed PIM-1 (shown in FIGS. 33-34), the very high CO₂/N₂ selectivity in PIM-1-C3-TA is a result of two factors: (i) amine functionality; and (ii) diminished surface area which provides much less adsorption media for inert gasses such as N₂.

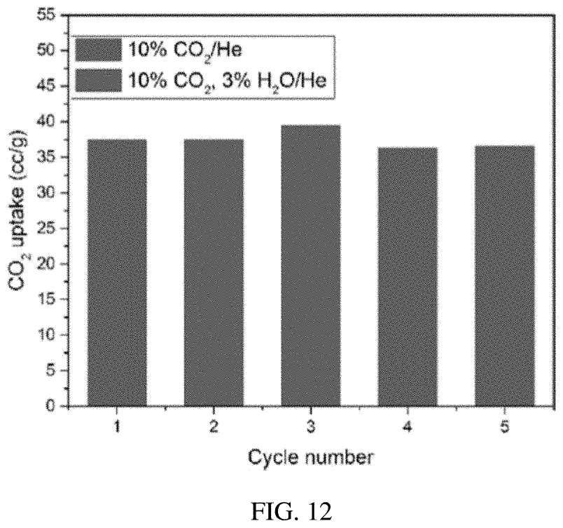

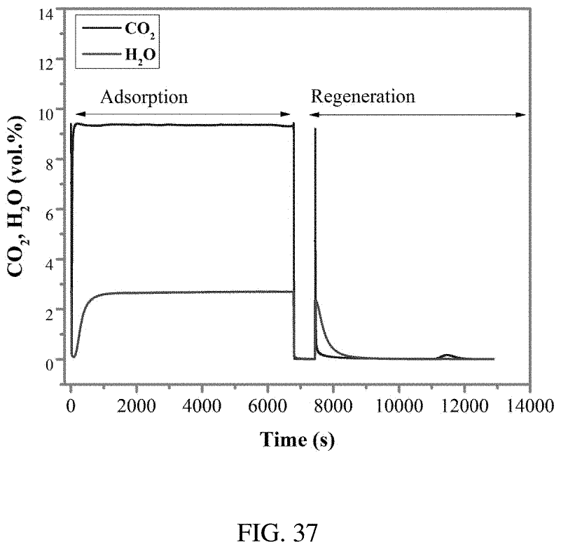

CO₂ capture properties are further evaluated for the best performing sorbent, PIM-1-C3-TA, with 3% humidity using dynamic breakthrough curves at 308K (which is shown in FIG. 37). The sorbent was tested under five adsorption/regeneration cycles, shown in FIG. 12. The performance of the sample was first assessed under 10% CO₂/He (dry conditions) to establish a baseline performance, and afterwards it was cycled twice under humid conditions (10% CO₂, 3% H₂O/He) until saturation of CO₂ and H₂O was achieved. The sorbent was then tested again under dry conditions to determine if exposure to humidity had caused any lasting changes to the material. Regeneration was carried out at 358K under helium for all five cycles. The breakthrough results showed that CO₂ uptake was 37.4 cc/g under dry conditions and increased slightly to 39.4 cc/g in the presence of H₂O.

After the humid cycles, testing the sorbent under dry conditions showed that CO₂ uptake remained stable at 36.0 cc/g. For the limited number of cycles used, the sorbent appears to be stable in a humid environment.

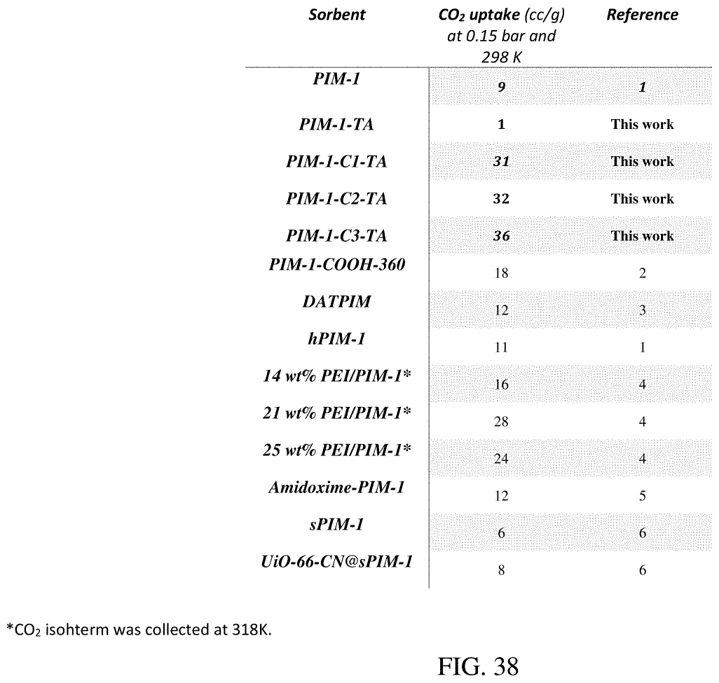

As explained in detail, above, the synthesis, characterization, and performance testing of new chemisorbent materials based on carboxylic acid functionalized PIM-1 microporous polymers is taught. Primary amines are appended to the polymers through acid-base and hydrogen bonding interactions. The sorbents showed the highest CO₂ uptake performance achieved to date in all reported functionalized and non-functionalized PIM based polymers (as shown in FIG. 38). Moreover, high CO₂ uptake performance was maintained even in humid conditions and after multiple cycles. Finally, the disclosed sorbents are soluble in common solvents and are processable into a variety of geometries.

Having disclosed various embodiments, it should be appreciated that the disclosed structures and processes exhibit advantages over conventional processes. For example, this disclosure includes the first example of carboxylated porous polymer (PIM-1) based sorbent. The disclosure also teaches an early example of acid-base interaction in a PIM-1 polymer sorbent. Also, the disclosed sorbent shows very high CO₂ separation properties compared to other polymeric sorbents as well as neat PIM-1. Additionally, the disclosed compositions and processes are simple, scalable, and cost-effective (by comparison, metal organic framework (MOF) sorbents are costly to mass produce and require more complex synthesis procedures). Furthermore, the disclosed sorbent is easily processible into different geometries and morphologies as the disclosed sorbent can dissolve in polar solvents such as dimethylacetamide; this is not true for other sorbents such as carbons, MOFs, silicas, etc. Next, the disclosed sorbent possesses an easily functionalized chemical structure due to the many chemical handles available on the polymer chain and, also, the disclosed sorbent exhibits high chemical and thermal stability. Moreover, the disclosed sorbent features tunable textural properties (pore size, surface area etc.) and can be applied in many different gas capture applications.

For purposes of clarity, some embodiments of the invention include a process comprising synthesizing a polymer with intrinsic microscopy (PIM-1) by polycondensation reaction of one-dimensional monomers.

For such embodiments the PIM-1 comprises a nitrile (—CN) group. The one-dimensional monomers comprise 3,3,3′3′-tetramethyl-1,1′-spirobisindane-5,5′,6,6′-tetrol (TTSBI) and 1,3-dicyanotetrafluorobenzene (DCTB). The process further comprises functionalizing the PIM-1 with a carboxylic acid (—COOH) group by converting the —CN to the —COOH. The functionalizing of the PIM-1 results in a hydrolyzed polymer (PIM-1-Cn). The degree of functionalization of the PIM-1 is controlled, in part, by adjusting a reaction temperature, adjusting a reaction time, or both. The process further comprises reacting the PIM-1-Cn through an acid-base interaction. The PIM-1-Cn is reacted with tris(2-aminoehtyl)amine (TAEA). The reacted PIM-1-Cn results in a primary amine-appended sorbent (PIM-1-Cn-TA).

In a specific embodiment of the process, the reaction temperature is approximately twenty-five degrees Celsius (25° C.) and the reaction time is approximately twenty-four (24) hours. In another embodiment, the reaction temperature is approximately one-hundred-and-twenty degrees Celsius (120° C.) and the reaction time is approximately ninety (90) minutes. In yet another embodiment, the reaction temperature is approximately one-hundred-and-twenty degrees Celsius (120° C.) and the reaction time is approximately two-hundred-and-ten (210) minutes.

Broadly, one embodiment of the process comprises functionalizing a polymer with intrinsic microscopy (PIM-1) with a carboxylic acid (—COOH) group. The functionalizing of the PIM-1 results in a hydrolyzed polymer (PIM-1-Cn). In this embodiment, the process further comprises reacting the PIM-1-Cn with a primary amine. The reacted PIM-1-Cn results in an amine-appended sorbent (PIM-1-Cn-TA).

Any process descriptions or blocks in flow charts should be understood as representing steps in a process, and alternate implementations are included within the scope of the preferred embodiment of the present disclosure in which the steps may be executed out of order from that shown or discussed, including substantially concurrently or in reverse order, as would be understood by those reasonably skilled in the art of the present disclosure.

Although exemplary embodiments have been shown and described, it will be clear to those of ordinary skill in the art that a number of changes, modifications, or alterations to the disclosure as described may be made. For example, it is possible to use different acidic sites of PIM-1 other than carboxylic acid. Also, other primary amines such as polyethylenimine, diethylenediamine, ethylendiamine, etc., can be used. Furthermore, the acid-base interaction approach can be used in other PIM-based polymer materials such as PIM-7. Additionally, polymer blends, such as PIM-1 and polyphosphazenes, can be used in the base sorbent to enhance gas separation characteristics, such as CO₂/N₂ selectivity. Also, there can be different morphologies of the sorbent in which surface area and porosity have been altered. All such changes, modifications, and alterations should therefore be seen as within the scope of the disclosure.

What is claimed is:

1. A chemical structure of:

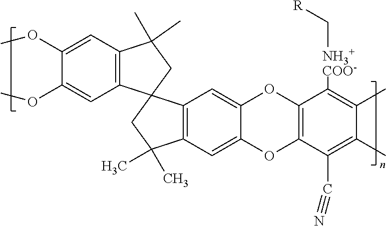

2. The structure of claim 1, R being one selected from the group consisting of:

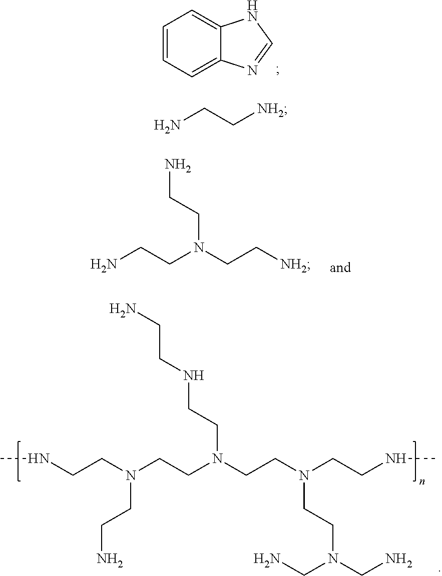

3. A process comprising:
synthesizing a polymer with intrinsic microscopy (PIM-1) by polycondensation reaction of one-dimensional monomers, the PIM-1 comprising a nitrile (—CN) group, the one-dimensional monomers comprising:
3,3,3′3′-tetramethyl-1,1′-spirobisindane-5,5′,6,6′-tetrol (TTSBI); and
1,3-dicyanotetrafluorobenzene (DCTB);
functionalizing the PIM-1 with a carboxylic acid (—COOH) group by converting the —CN to the —COOH, the functionalizing of the PIM-1 resulting in a hydrolyzed polymer (PIM-1-Cn), a degree of functionalization of the PIM-1 being controlled, in part, by:
adjusting a reaction temperature; and
adjusting a reaction time; and
reacting the PIM-1-Cn through an acid-base interaction, the PIM-1-Cn being reacted with tris(2-aminoehtyl)amine (TAEA), the reacted PIM-1-Cn resulting in a primary amine-appended sorbent (PIM-1-Cn-TA).

4. The process of claim 3, further comprising:
casting the amine-appended sorbent into a product selected from the group consisting of:
a pellet;
a film;
a solid fiber strand; and
a hollow fiber strand.

5. The process of claim 3, wherein the amine-appended sorbent has a CO₂ uptake capacity of at least thirty-six cubic centimeters per gram (≥36 cc/g).

6. The process of claim 3, wherein:
the reaction temperature is approximately twenty-five degrees Celsius (25° C.); and
the reaction time is approximately twenty-four (24) hours.

7. The process of claim 3, wherein:
the reaction temperature is approximately one-hundred-and-twenty degrees Celsius (120° C.); and
the reaction time is approximately ninety (90) minutes.

8. The process of claim 3, wherein:
the reaction temperature is approximately one-hundred-and-twenty degrees Celsius (120° C.); and
the reaction time is approximately two-hundred-and-ten (210) minutes.

9. A process comprising:
functionalizing a polymer with intrinsic microscopy (PIM-1) with a carboxylic acid (—COOH) group, the functionalizing of the PIM-1 resulting in a hydrolyzed polymer (PIM-1-Cn); and
reacting the PIM-1-Cn with a primary amine, the reacted PIM-1-Cn resulting in an amine-appended sorbent (PIM-1-Cn-TA).

10. The process of claim 9, further comprising synthesizing the PIM-1 by polycondensation reaction of one-dimensional monomers.

11. The process of claim 10, the one-dimensional monomers comprising:
3,3,3′3′-tetramethyl-1,1′-spirobisindane-5,5′,6,6′-tetrol (TTSBI); and
1,3-dicyanotetrafluorobenzene (DCTB).

12. The process of claim 9, the PIM-1 comprising a nitrile (—CN) group.

13. The process of claim 9, the functionalizing of the PIM-1 comprising converting the —CN to the —COOH.

14. The process of claim 9, further comprising controlling a degree of functionalization of the PIM-1 by:
adjusting a reaction temperature; and
adjusting a reaction time.

15. The process of claim 14, the controlling of the degree of functionalization of the PIM-1 comprising adjusting a reaction temperature.

16. The process of claim 15, the reaction temperature being one selected from the group consisting of:
approximately twenty-five degrees Celsius (25° C.); and
approximately 120° C.

17. The process of claim 14, the controlling of the degree of functionalization of the PIM-1 comprising adjusting a reaction time.

18. The process of claim 17, the reaction time being one selected from the group consisting of:
approximately twenty-four (24) hours;
approximately ninety (90) minutes; and
approximately two-hundred-and-ten (210) minutes.

19. The process of claim 9, the PIM-1-Cn being reacted with tris(2-aminoehtyl)amine (TAEA).

20. The process of claim 9, the PIM-1-Cn being reacted in an acid-base reaction.
